(19) United States
(12) Patent Application Publication
(10) Pub. No.: US 2025/0108739 A1
(43) Pub. Date: Apr. 3, 2025

(54) VEHICLE SEAT

(71) Applicant: TACHI-S CO., LTD., Tokyo (JP)

(72) Inventor: Tsutomu HADA, Tokyo (JP)

(73) Assignee: TACHI-S CO., LTD., Tokyo (JP)

(21) Appl. No.: 18/829,018

(22) Filed: Sep. 9, 2024

(30) Foreign Application Priority Data
Sep. 29, 2023 (JP) 2023-169031

(51) Int. Cl. B60N 2/64

(52) U.S. Cl. CPC B60N 2/64

(57) ABSTRACT

To improve sitting comfort performance and posture stability using a method other than increasing hardness of a seat pad.

The present disclosure provides a vehicle seat, constituted of: a seat including a front insert wire and a rear insert wire which are disposed inside a seat pad, a backrest, and a suspending structure configured to engage a seat cover with a front suspending groove and a rear suspending groove of the seat pad. The front insert wire includes a front main load receiving portion which protrudes backward from a peripheral portion, and the rear insert wire includes a rear main load receiving portion which protrudes forward from a peripheral portion. The rear insert wire is disposed at a position where at least the rear main load receiving portion is ahead of the rear suspending groove, and the front insert wire is disposed at a position where at least the front main load receiving portion is behind the front suspending groove.

### BACKGROUND

### Field

The present disclosure relates to a vehicle seat.

### Description of Related Art

As a seat cushion constituting a vehicle seat, a seat cushion including a seat pad made of foam, a seat cushion where insert wires, which elastically deform, are inserted inside the seat pad, and the like are used (e.g. Patent Publication JP-A-2012-091544). These states of supporting an occupant using the seat pad, insert wires, and the like influence the sitting comfort performance and the posture stability. For example, if the pressure balance of the lower half of the body of an occupant in the front-back direction is appropriate, and the occupant can maintain their pelvis in an erected state, the sitting comfort performance and the posture stability are good, but if not, the sitting comfort performance and the posture stability naturally become poor.

Specifically, the sitting comfort performance and the posture stability are affected in the following cases. For example, if the seat pad is soft, the sinking of the buttocks and the dropping of the pelvis (collectively called “buttocks sinking” in the present description) become excessive, and the pelvis rolls backward or inclines backward, and posture becomes poor (bad state) (see FIG. 19). If the buttocks slip forward due to poor posture or the like (called “forward slippage” of buttocks in the present description), a sensation of the muscles of the buttocks separating from the bone and in some cases even a numbness (“shearing sensation”) is generated. The shearing sensation tends to be more conspicuous if buttocks sinking occurs along with the forward slippage.

One conventional means to improve the low evaluation due to such phenomena and sensation of “buttocks sinking”, “forward slippage” and “shearing sensation” is to increase the hardness of a seat pad made of urethane, so that these problems are improved.

### SUMMARY

However, there is a limit to improving the sitting comfort performance and the posture stability by merely increasing the hardness of the seat pad.

With the foregoing in view, it is an object of the present disclosure to provide a vehicle seat of which sitting comfort performance and posture stability are further improved by a method other than increasing the hardness of the seat pad.

To solve the above problems, the present inventors paid attention to insert wires 40′ and 50′, which are components of a seat cushion 20′, and proceed with various examinations (see FIG. 16 and the like). In prior arts, it was a commonly held idea to avoid a layout where the insert wires 40′ and 50′ linearly contact the body at locations immediately under the buttocks and the pelvis of an occupant if a structure focusing on sitting comfort is implemented (see FIG. 16 and FIG. 17). Further, in the case where the vehicle seat includes a suspending structure where suspended portions of the seat cover are engaged with a front suspending groove 71′ and a rear suspending grove 72′ formed in a seat pad 21′, and the seat cover is suspended and supported, it is a commonly held idea that the front insert wire 40′ is disposed ahead of the front suspending groove 71′, and the rear insert wire 50′ is disposed behind the rear suspending groove 72′ (see FIG. 18). The present inventors fundamentally reviewed these commonly held conventional ideas and technical common sense, and continued to study regardless conventional wisdom, and as a result, obtained new knowledge which may solve to these problems.

Based on this knowledge, an aspect of the present disclosure is a vehicle seat constituted of:
a seat including a seat pad, a front insert wire which is disposed inside the seat pad, and a rear insert wire which is disposed inside the seat pad and is disposed on the rear side of the front insert wire in a front-back direction of the vehicle seat;
a backrest which is reclinable around a turning fulcrum; and
a suspending structure configured to suspend and support a seat cover by engaging suspended portions of the seat cover with a front suspending groove and a rear suspending groove formed in the seat pad, wherein
the front insert wire, which is bent at a plurality of bent portions, includes a front main load receiving portion which protrudes backward from a peripheral portion,
the rear insert wire, which is bend at a plurality of bent portions, includes a rear main load receiving portion which protrudes forward from a peripheral portion,
the rear insert wire is disposed at a position where at least the rear main load receiving portion is ahead of the rear suspending groove, and
the front insert wire is disposed at a position where at least the front main load receiving portion is behind the front suspending groove.

In this vehicle seat, the rear main load receiving portion of the rear insert wire is located in a predetermined range, and the distance between the rear main load receiving portion and the front main load receiving portion of the insert wire is within a predetermined range, thereby the front main load receiving portion and the rear main load receiving portion can effectively support the pelvis, especially around the ischium, of the occupant. Then such phenomena and feeling as buttocks sinking, forward slippage and shearing sensation of the occupant can be controlled without making the seat pad harder. By improving sitting comfort without creating a shearing sensation, as well as softening the seat pad, a more comfortable sitting feeling can be implemented.

In the above vehicle seat, at least one of the front main load receiving portion and the rear main load receiving portion may be constituted of a straight portion which extends in a left-right direction of the vehicle seat.

In the above vehicle seat, at least one of the front main load receiving portion and the rear main load receiving portion may be formed to be bilaterally symmetrical with respect to a center line of the vehicle seat in the left-right direction.

In the above vehicle seat, the front insert wire may be inclined in a side view of the vehicle seat, so as to be lower in a backward direction.

In the above vehicle seat, the rear insert wire may be inclined in the side view of the vehicle seat, so as to be lower in a forward direction from a peripheral portion of the rear main load receiving portion to the rear main load receiving portion.

In the above vehicle seat, the rear main load receiving portion may be located at a lowest point in the rear insert wire.

In the above vehicle seat, a length of the front main load receiving portion in the left-right direction may be longer than the length of the rear main load receiving portion in the left-right direction.

In the above vehicle seat, the rear insert wire and the front insert wire may be disposed such that at least a part of the front main load receiving portion is located ahead of the rear main load receiving portion.

In the above vehicle seat, a number of the bent portions of the front insert wire and a number of the bent portions of the rear insert wire may be the same.

In the above vehicle seat, the bent portion of the rear insert wire may be bent at an obtuse angle.

In the above vehicle seat, the front insert wire may be disposed behind the front suspending groove, and the rear insert wire may be disposed ahead of the rear suspending groove.

In the above vehicle seat, the rear insert wire may be disposed at a position where a distance from the turning fulcrum to the rear main load receiving portion is at least 170 mm, and the front insert wire may be disposed at a position where the distance between the rear main load receiving portion and the front main load receiving portion is at least 60 mm and not more than 70 mm.

According to the present disclosure, a vehicle seat, of which sitting comfort performance and posture stability can be further improved by a method other than increasing the hardness of the seat pad, can be provided.

### BRIEF DESCRIPTION OF DRAWINGS

FIG. 1 is a perspective plan view depicting an inner structure of a seat cushion (seat) of a vehicle seat according to an embodiment of the present disclosure;

FIG. 2 is a perspective view depicting an inner structure of the seat cushion of the vehicle seat;

FIG. 3 is a diagram depicting a cross-sectional structure of the vehicle seat sectioned at the III-III line in FIG. 1, or the III-III line in FIG. 2;

FIG. 4A is a diagram depicting a relationship between a cross-sectional structure indicated in FIG. 3 and an ischium position of the occupant;

FIG. 4B is an enlarged view of a portion of a suspending structure in FIG. 3 and FIG. 4A;

FIG. 5 is a perspective view depicting an example of a front insert wire;

FIG. 6 is a perspective view depicting an example of a rear insert wire;

FIG. 7 is a plan view depicting an example of disposing the front insert wire, the rear insert wire, and the other wires (outer right wire, outer left wire, inner right wire and inner left wire);

FIG. 8 is a diagram depicting a relationship of the front insert wire and the rear insert wire indicated in FIG. 7 and the ischium position of an occupant;

FIG. 9 is a diagram depicting a positional relationship of a front straight portion (front main load receiving portion) of the front insert wire and a rear straight portion (rear main load receiving portion) of the rear insert wire;

FIG. 10A is a diagram for describing each bent portion of the front insert wire and the rear insert wire respectively;

FIG. 10B is another diagram for describing each bent portion of the front insert wire and the rear insert wire respectively;

FIG. 10C is a diagram for describing the front straight portion of the front insert wire and the rear straight portion of the rear insert wire;

FIG. 11 is a diagram for describing the rear insert wire of which bent portion is bent at an obtuse angle;

FIG. 12 is a diagram depicting the front insert wire and the rear insert wire where bent portions are added to the terminal portions;

FIG. 13 is a diagram depicting an example of a cross-sectional structure in a case of installing a heater/air conditioning mat in the vehicle seat;

FIG. 14 is a diagram depicting another example of the front insert wire and the rear insert wire;

FIG. 15 is a diagram for describing a positional relationship of vent holes, the front insert wire, and the rear insert wire in a vehicle seat including an air conditioning mat;

FIG. 16 is a plan view depicting a seat cushion of a conventional vehicle seat for reference;

FIG. 17 is a perspective view depicting an internal structure of the seat cushion of the conventional vehicle seat for reference;

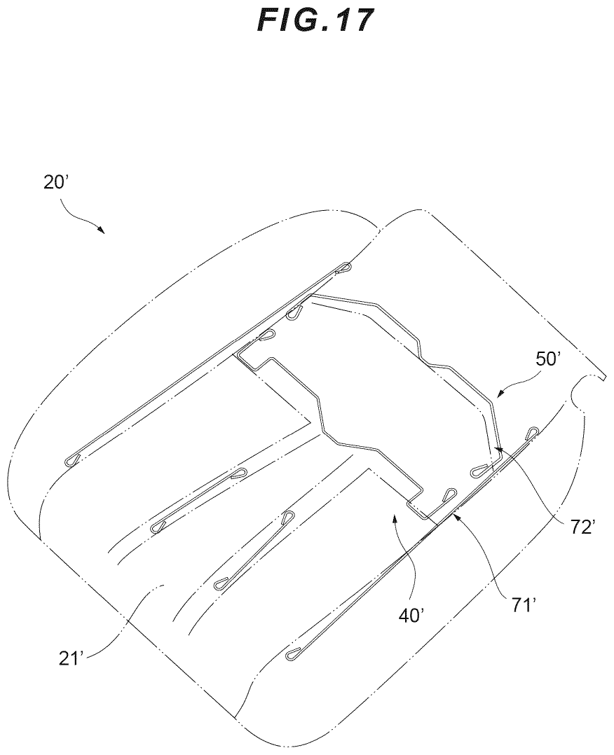

FIG. 18 is a cross-sectional schematic diagram sectioned at the XVIII-XVIII line in FIG. 16, indicating the structure of the seat cushion of the conventional vehicle seat for reference; and

FIG. 19 is a diagram for describing a reaction force and posture of the pelvis in a seat cushion of a vehicle seat.

### DETAILED DESCRIPTION

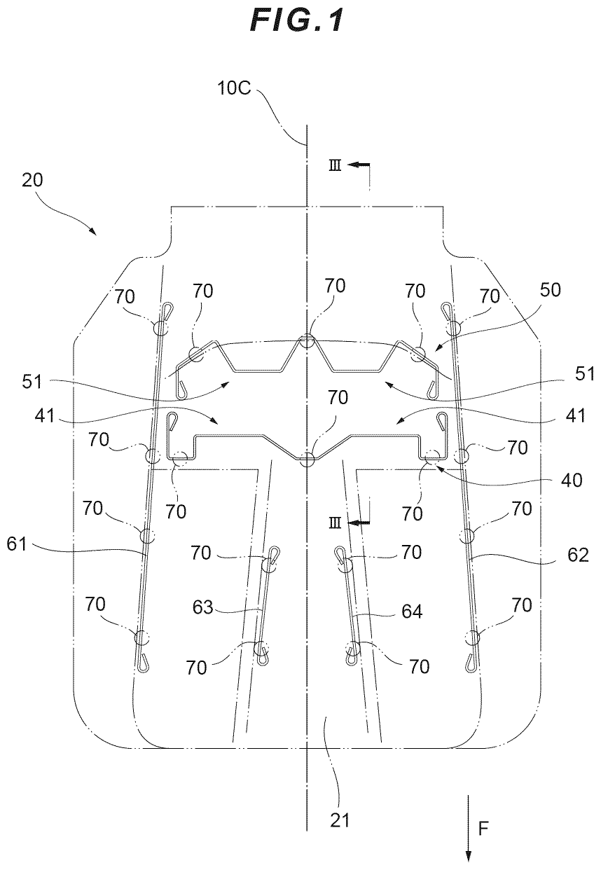

Embodiments of the present disclosure will now be described in detail (see FIG. 1 and the like).

In the following, “the front side” of a vehicle seat 10 is a side where an occupant of the vehicle seat 10 faces (normally the traveling direction of the vehicle; indicated by a reference sign F in some drawings), and “the rear side” and “the left-right direction” (or width direction) are based on this definition.

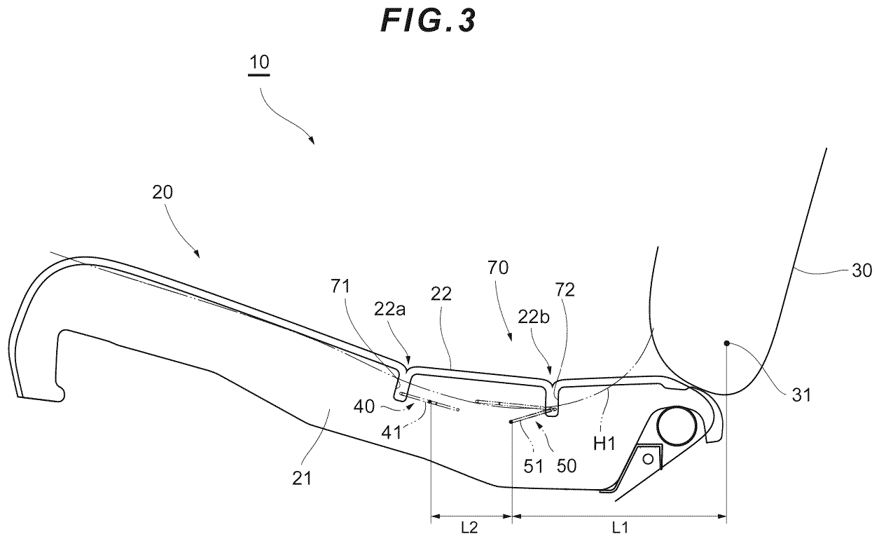

The vehicle seat 10 according to the present disclosure includes a seat cushion (seat) 20 and a seat back (backrest) 30. The seatback 30 is reclinable around a turning fulcrum 31 (see FIG. 3 and the like). In FIG. 3 and the like, hatching is omitted to clearly indicate an interval structure, particularly to indicate a front insert wire 40 and a rear insert wire 50.

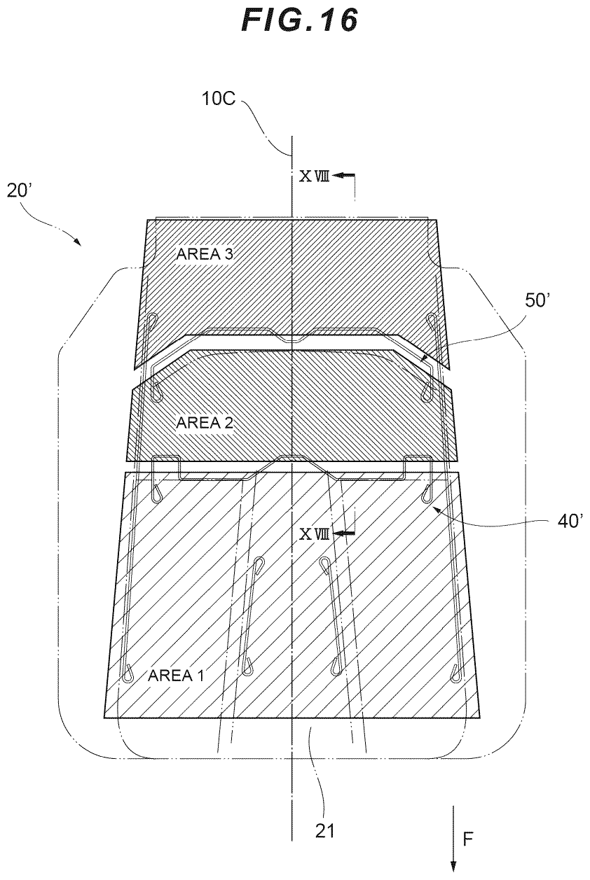

In the seat cushion 20, a seat pad 21 made of foam is included. The vehicle seat 10 of the present embodiment includes a suspending structure 70 which suspends and supports the seat cover 22 by engaging suspended portions 22a and 22b of a seat cover 22 with a front suspending groove 71 and a rear suspending groove 72 formed in the seat pad 21 (see FIG. 3 and the like). In the present description, out of the three areas of the seat cushion 20 which is separated by the front suspending groove 71 and the rear suspending groove 72 extending in the left-right direction, the front area is called the area 1, the intermediate area is called the area 2, and the rear area is called the area 3 for convenience (see FIG. 16).

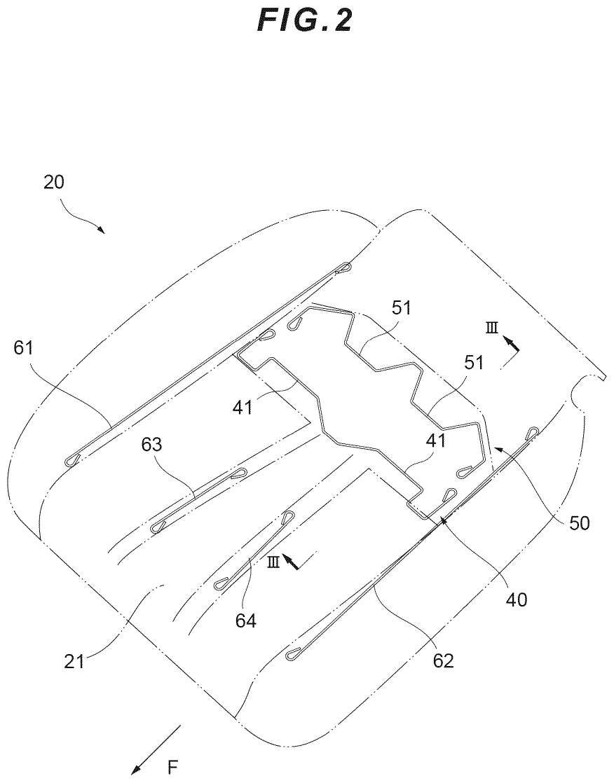

Insert wires which elastically deform are disposed inside the seat pad 21, so as to support the load of the occupant. In the vehicle seat 10 of the present embodiment, the front insert wire 40, the rear insert wire 50, an outer right wire 61, an outer left wire 62, an inner right wire 63 and an inner left wire 64 are disposed as the insert wires (see FIG. 2 and the like). The outer right wire 61 is disposed on the outer right side of the seat pad 21, and the outer left wire 62 is disposed on the outer left side of the seat pad 21, so as to be bilaterally symmetric with respect to a center line 10C of the vehicle seat 10 extending in the left-right direction (see FIG. 1 and the like). The inner right wire 63 is disposed on the inner side of the outer right wire 61 in the area 1 of the seat pad 21, and the inner left wire 64 is disposed on the inner side of the outer left wire 62 in the area 1 of the seat pad 21, so as to be bilaterally symmetric with respect to the center line 10C (see FIG. 1 and the like).

### Front Insert Wire and Rear Insert Wire

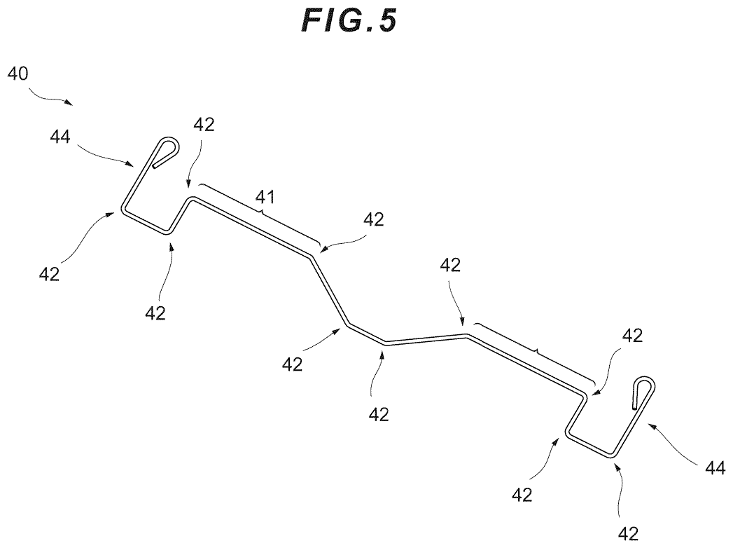

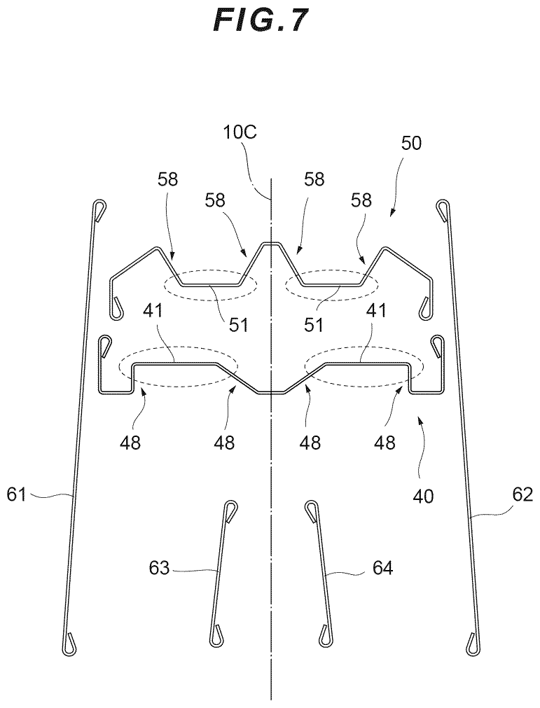

The front insert wire 40 is disposed near the boundary between the area 1 and the area 2, and in the case of the present disclosure, the front insert wire 40 is located at a position where most of the front insert wire 40 is included in the area 2, in a state of extending in the left-right direction (see FIG. 1, FIG. 3 and the like). The front insert wire 40 is bent at a plurality of bent portions 42, and is bilaterally symmetrical such that one front straight portion 41, which extends between predetermined bending portions 42, in the left-right direction, is disposed at the left and right respectively (total of two front straight portions 41) (see FIG. 5 and the like). The front straight portion 41 protrudes backward from a peripheral position (indicated by the reference number 48 in FIG. 7) of this front straight portion 41, and in the present embodiment, the peripheral portion 48 of the front straight portion 41 is disposed so as to protrude backward from a portion that is suspended and supported by a suspending structure 70, and each portion around the front straight portion 41 functions as a front main load receiving portion which receives a large amount of the load of the occupant (see FIG. 7 and the like). The portion that is called the front straight portion 41 in the present embodiment is merely a preferable example of a portion that functions as the front main load receiving portion. For example, the front straight portion 41 may have a gently curved shape, which is not straight, if the function of the front main load receiving portion, to be described below, can be performed. In other words, it is preferable that the front straight portion 41 is straight, but is not limited thereto.

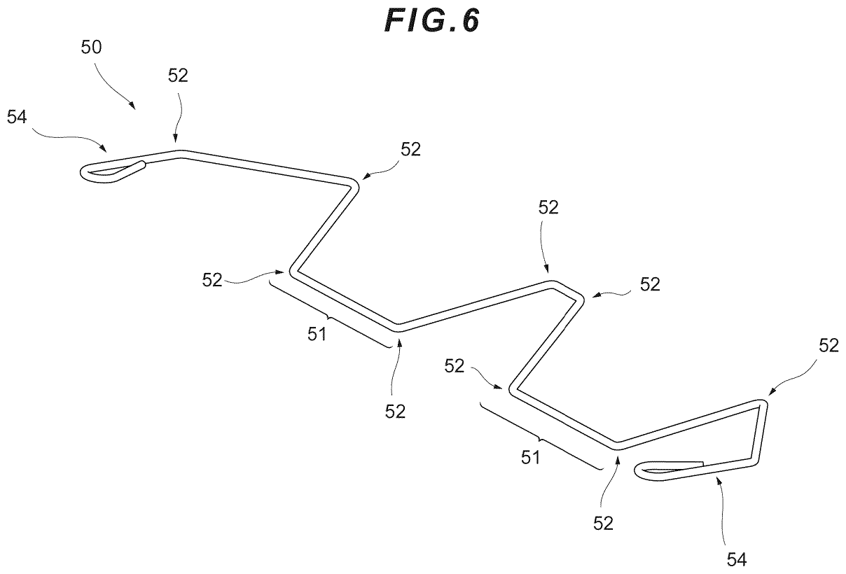

The rear insert wire 50 is disposed near the boundary between the area 2 and the area 3, and in the case of the present disclosure, the rear insert wire 50 is located at a position where most of the rear insert wire 50 is include in the area 2, in a state of extending in the left-right direction (see FIG. 1, FIG. 3 and the like). The rear insert wire 50 is bent at a plurality of bent portions 52, and is bilaterally symmetrical such that one rear straight portion 51, which extends between predetermined bending portions 52, in the left-right direction, is disposed at the left and right respectively (total of two rear straight portions 51) (see FIG. 6). The rear straight portion 51 protrudes forward from a peripheral portion (indicated by the reference number 58 in FIG. 7) of this rear straight portion 51, and in the present embodiment, the peripheral portion 58 of the rear straight portion 51 is disposed so as to protrude forward from a portion that is suspended and supported by the suspending structure 70, and each portion around the rear straight portion 51 functions as a rear main load receiving portion which receives a large amount of the load of the occupant (see FIG. 7 and the like). The portion that is called the rear straight portion 51 in the present embodiment is merely a preferable example of a portion that functions as the rear main land receiving portion. For example, the rear straight portion 51 may have a gently curved shape, which is not straight, if the function of the rear main load receiving portion, to be described below, can be performed. In other words, it is preferable that the rear straight portion 51 is straight, but is not limited thereto.

The rear insert wire 50 is disposed at a position where a distance L1, from a turning fulcrum 31 of the seatback 30 to the rear straight portion 51, is a predetermined length (see FIG. 3). L1 is at least 155 mm, preferably at least 170 mm.

The front insert wire 40 is disposed at a position where a distance L2, between the rear straight portion 51 and the front straight portion 41, is a predetermined length (see FIG. 3). L2 is preferably at least 60 mm, and not more than 70 mm.

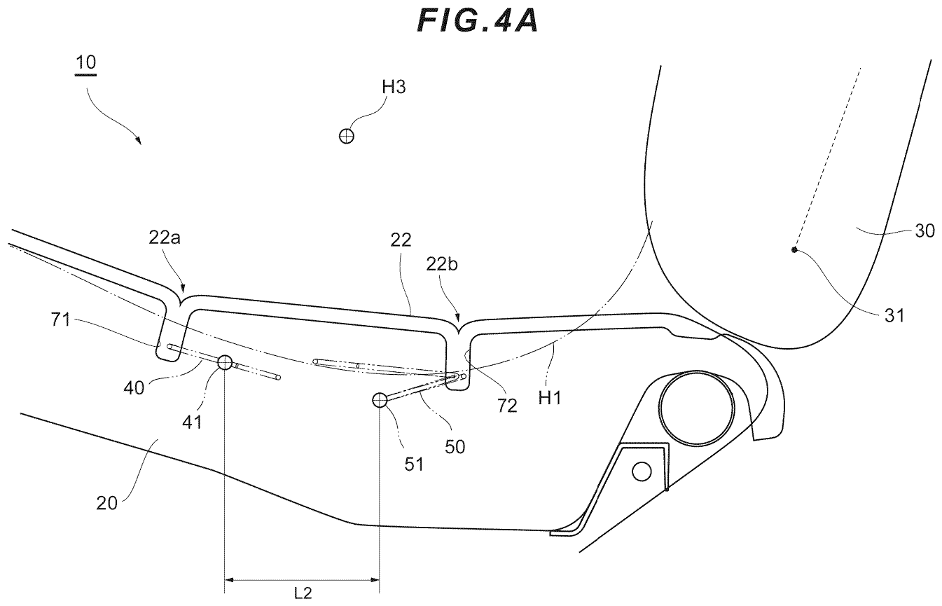

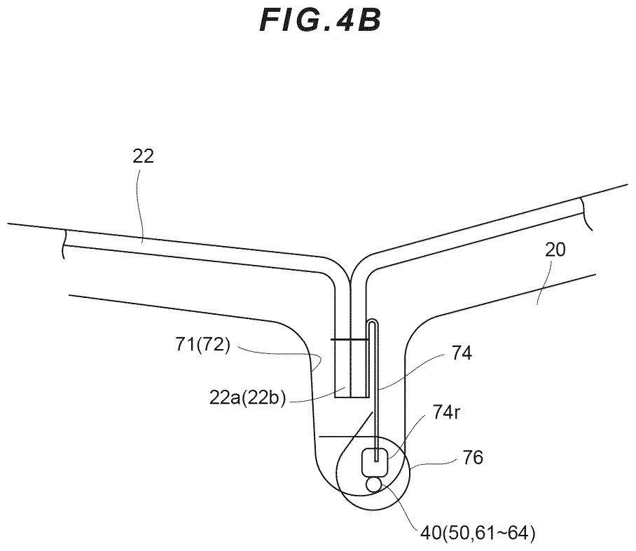

In this vehicle seat 10, in some cases the front insert wire 40 is located behind the front suspending groove 71, and the rear insert wire 50 is located ahead of the rear suspending groove 72 (see FIG. 3, FIG. 4A and the like).

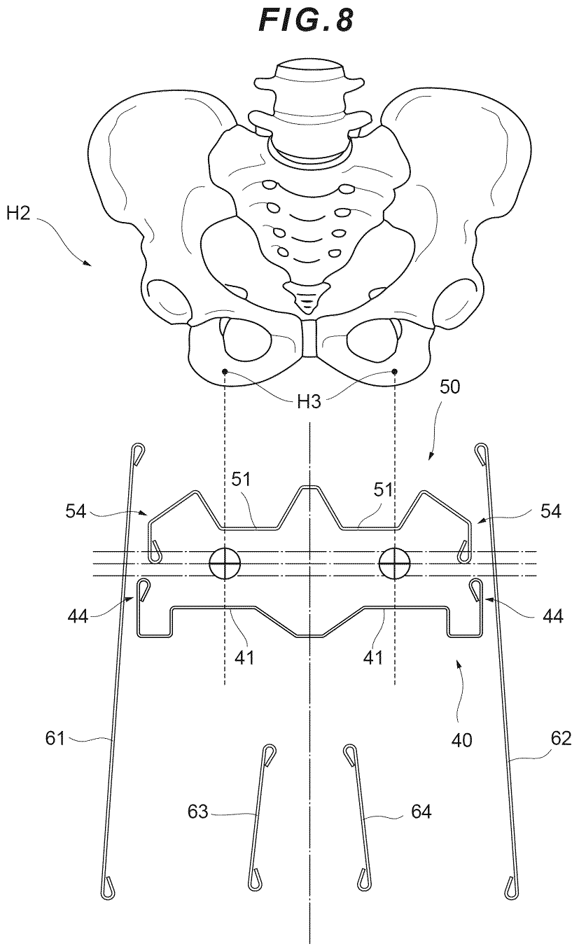

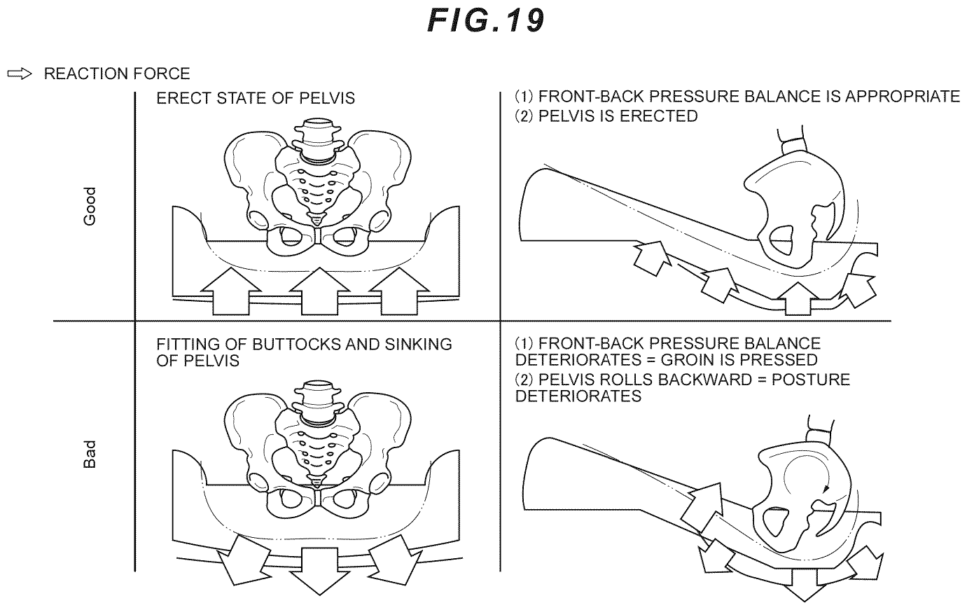

In the vehicle seat 10 described above, an area near the pelvis H2 in the buttocks H1 of the occupant, particularly an area around the ischium H3, can be effectively supported using the rear straight portion 51 of the rear insert wire 50 and the front straight portion 41 of the front insert wire 40, which are disposed at predetermined locations within predetermined ranges (see FIG. 4A and FIG. 8). Thereby such phenomena or sensation as buttocks sinking, forward slippage and shearing sensation felt by the occupant can be controlled without increasing the hardness of the seat pad 21. In conventional vehicle seats, where the insert wires linearly contact the body at the locations immediately under the buttocks H1 and the pelvis H2 of the occupant normally have been avoided (somewhat of a taboo), in order to ensure the sitting comfort performance, and it was common to dispose the insert wires in the area 1 or the area 3, avoiding the area 2. In the present embodiment, a conventional layout is reconsidered from the point of view of improving the sitting comfort performance and posture stability by a method other than increasing the hardness of the seat pad 21, and the distance between the rear straight portion 51 and the front straight portion 41, which become the main load receiving portions, is appropriately shortened, whereby the insert wire is located in the region of the area 2, even if the insert wire is disposed in the range of the area 2 which has been avoided in the prior art. This was taboo in the conventional layout, but by using a method previously unused according to the conventional common sense, functions which were not possible in the conventional structure can be implemented. Further, comparing a state where the buttocks sink and a state where the buttocks do not sink, the shearing sensation may increase in the former. In this vehicle seat 10, buttocks sinking is prevented by the rear insert wire 50, particularly by the rear straight portion 51, and the pressure balance of the lower half of the body of the occupant in the front-back direction is optimized, so that the pelvis of the occupant is in the erected state (a good state) (see FIG. 19). Furthermore, if the front insert wire 40 and the rear insert wire 50 are configured as above, bending can be uniform, which means that sitting comfort performance can be improved (thereby the pad can be softer).

With the foregoing in view, the vehicle seat 10, according to the present embodiment, is further configured as follows. Each aspect thereof will be sequentially described (see FIG. 3 and the like).

### Suspending Structure

An example of the suspending structure 70 will be described. The suspending structure 70 of the present embodiment includes: a suspending member 74 and a hog ring (C-ring) 76 to suspend the suspended portion 22a (22b) of the seat cover 22 with the insert wires (front insert wire 40, rear insert wire 50) (see FIG. 4B). One end of the suspending member 74 is fixed to the suspended portion 22a (22b) of the seat cover 22 by sewing or the like. On the other end of the suspending member 74, a resin portion 74r is disposed. By securing the resin portion 74r of the suspending member 74 and the insert wire using the hog ring 76, the seat cover 22 is suspended and inserted into the front suspending groove 71 (or rear suspending groove 72) of the seat cushion 20 (see FIG. 4B). The suspending structure of the other insert wires (outer right wire 61, outer left wire 62, inner right wire 63 and inner left wire 64 in the case of the present embodiment) are configured in the same manner (not illustrated). The positions and number of these suspending structures 70 are not especially limited. In the case of the vehicle seat 10 of the present embodiment, for example, the suspending structure 70 is disposed at each location indicated by a circle (O) in FIG. 1.

### Shapes of Front Insert Wire and Rear Insert Wire in Side View

In the side view of the vehicle seat 10 of the present embodiment, the front insert wire 40 is disposed in an inclined state, so as to be lower in the backward direction (see FIG. 3 and the like). In the side view of the vehicle seat 10 of the present embodiment, the rear insert wire 50 is disposed in an inclined state, so as to be lower in the forward direction from the peripheral portion 58 of the rear straight portion 51 to the rear straight portion 51 (see FIG. 3). Since the front insert wire 40 and the rear insert wire 50 are disposed to be closer to each other in the downward direction (that is, having a reverse fan shape) in the side view, the sinking buttocks H1 of the occupant when seating can be guided to a more appropriate sitting point, and thereby front slippage can be prevented and sitting comfort performance can be improved. The front insert wire 40 and the rear insert wire 50 also support the occupant seating at a predetermined seating position from the front-back direction, whereby stable posture can be maintained. The rear straight portion 51 may be located at the lowest point in the rear insert wire 50 (see FIG. 4A and the like).

### Lengths of Front Straight Portion and Rear Straight Portion in Left-Right Direction

In the vehicle seat 10 of the present embodiment, the length of the front straight portion 41 in the left-right direction is longer than the length of the rear straight portion 51 in the left-right direction (see FIG. 7, particularly portions enclosed by broken lines). This front insert wire 40 is disposed in an area from the front of the pelvis H2 to the groin of the occupant, and even if forward slippage of the buttocks H1 and a shearing sensation are generated or are about to be generated to the occupant, the occupant can be stably supported by the relatively wide front straight portion 41 (see FIG. 8 and the like).

### Positions of Front Straight Portion and Rear Straight Portion in Front-Back Direction

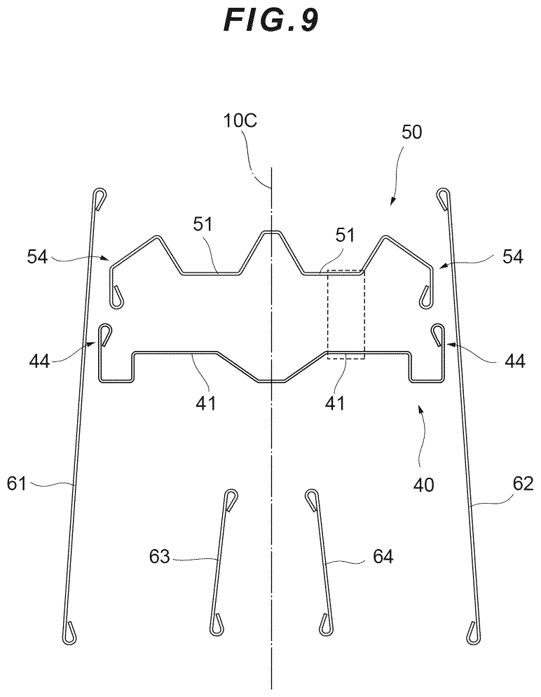

In the vehicle seat 10 of the present embodiment, the front insert wire 40 and the rear insert wire 50 are disposed such that at least a part of the front straight portion 41 is located ahead of the rear straight portion 51 (see FIG. 9 and the like). In other words, there is an area where the front insert wire 40 and the rear insert wire 50 overlap in the width direction (see the broken line portion in FIG. 9), and stability to support the occupant can be improved by securing such overlapped area as much as possible. The overlapping of the front straight portion 41 and the rear straight portion 51, which are portions that receive much of the body pressure from the pelvis H2 of the occupant, can also improve sitting comfort performance.

### Number of Bent Portions

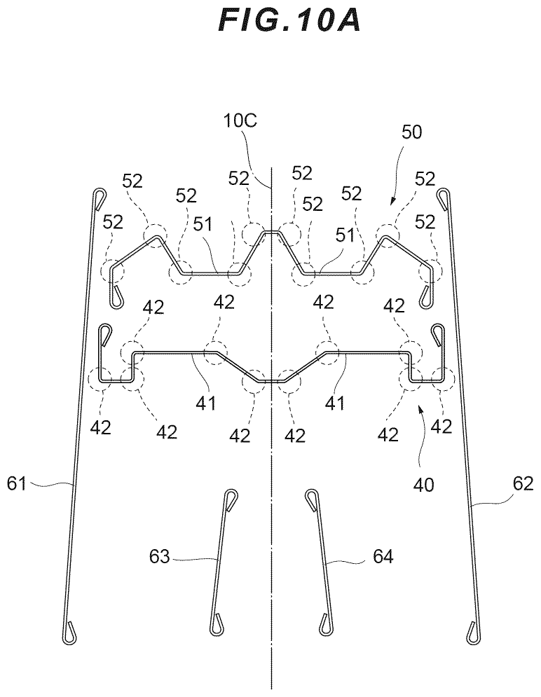

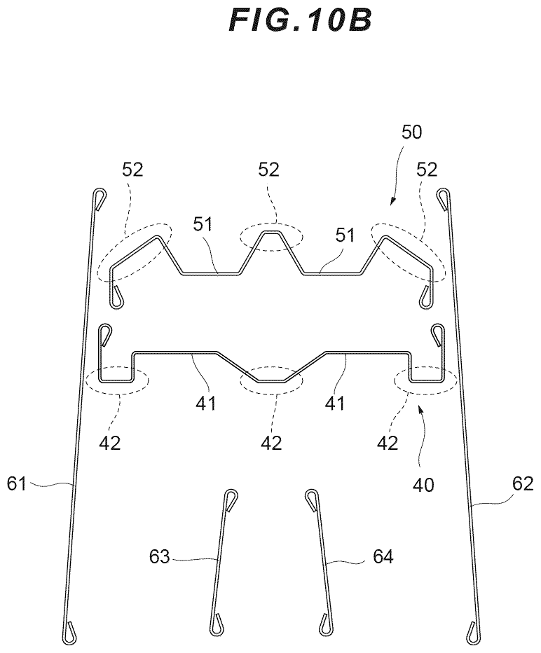

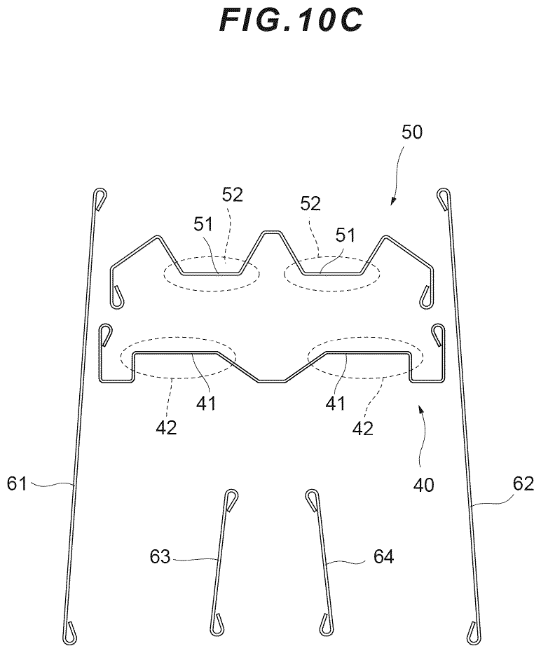

A number of bent positions 42 of the front insert wire 40 and a number of bent portions 52 of the rear insert wire 50 are not especially limited, but is a same number in the case of the present embodiment, for example (see FIG. 10A) (a number of bent portions is regarded as a number of bent points). Thereby a good left-right balance can be implemented. In the present description, the bent portion of the insert wire is called the “bent portion”, and is indicated by a broken line circle in FIG. 10A (see FIG. 10A), but each portion indicated by the broken line ellipse in FIG. 10B may be interpreted as the “bent portion”, or each portion indicated by the broken line ellipse in FIG. 10C may be interpreted as the “bent portion” (see FIG. 10B and FIG. 10C). In either interpretation, a number of the bent portions 42 of the front insert wire 40 and a number of the bent portions 52 of the rear insert wire 50 are the same in the present embodiment.

### State of Bent Portions

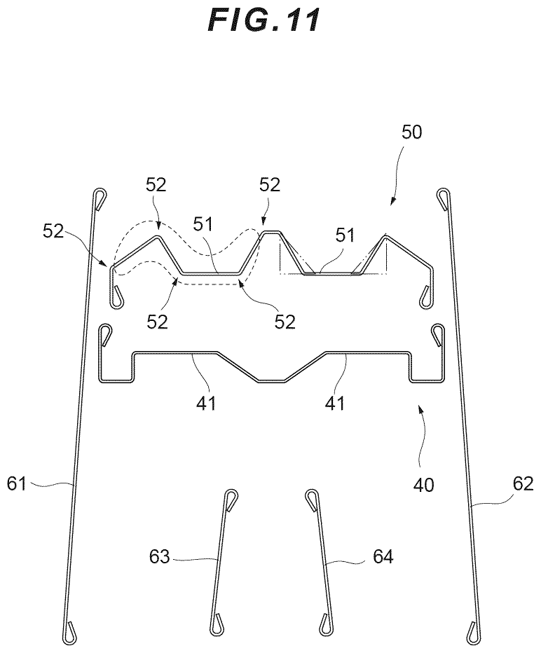

An angle of bending of the bent portions 42 and 52 may be an obtuse angle. In the rear insert wire 50 of the present embodiment, a part of the bent portions 52 have an obtuse angle, and the portion from the center to the sides have a gently bent or curved S shape (see FIG. 11 and the like). By having the rear insert wire 50 shaped as such, the bent sensation can be uniform, and good body pressure balance can be implemented.

### Shape of Terminal Portion of Insert Wire

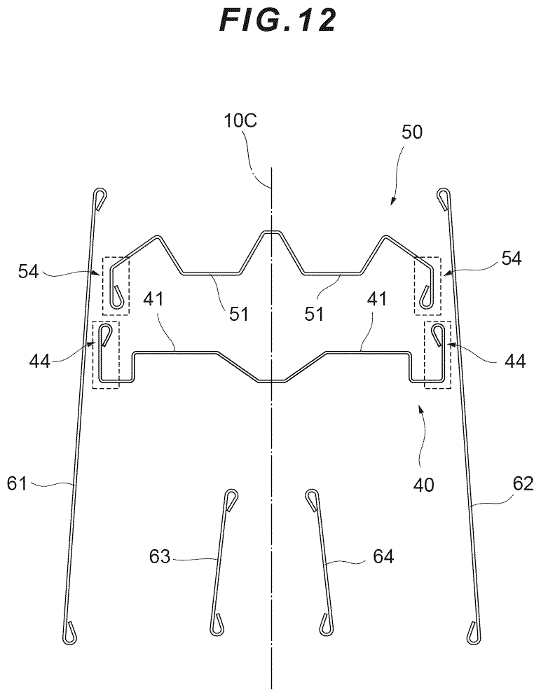

The shapes of the terminal portions (portions near the outer right wire 61 and the outer left wire 62) 44 and 54 of the front insert wire 40 and the rear insert wire 50 are not especially limited either, and, for example, these terminal portions 44 and 54 may be additionally bent (see FIG. 12). In this case, when the front insert wire 40 and the rear insert wire 50 are set in a foaming mold (not illustrated) of a pad, these terminal portions 44 and 54 can be aligned to the alignment plates (not illustrated) or the like protruding into the foaming mold. Therefore the front straight portion 41 and the rear straight portion 51 can be controlled or managed so that a targeted position, depth and angle, for stabilizing the posture.

### In a Case of Installing Heater/Air Conditioning Mat

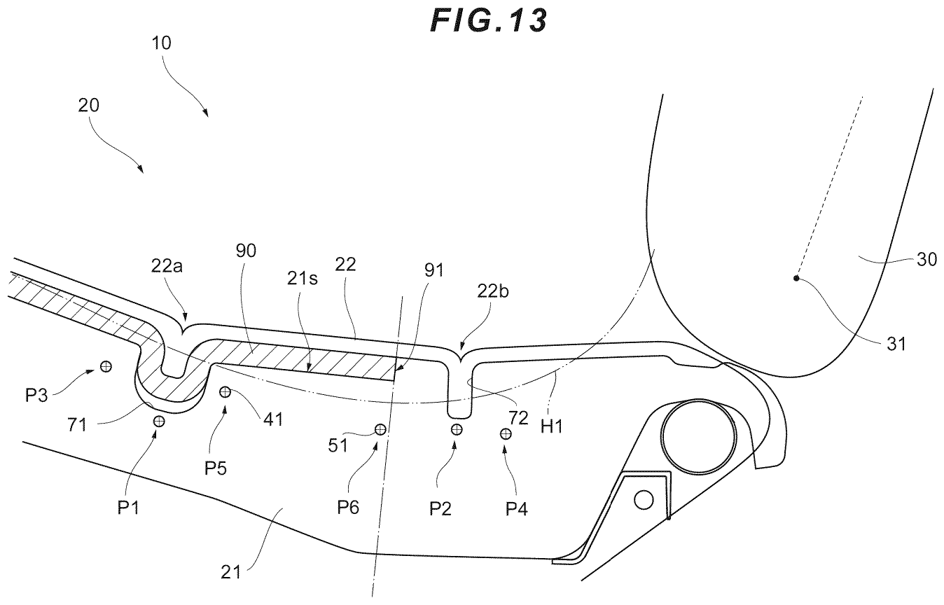

In the case of installing an air conditioning mat 90 integrated with a heater (not illustrated) in the vehicle seat 10, the front insert wire 40 and the rear insert wire 50 are disposed with attention to the following (see FIG. 13). If the air conditioning mat 90 is disposed between the suspending member 74, included in the seat cover 22, and the insert wires (e.g. front insert wire 40), disconnection of wiring of the heater may occur, hence disposing the front insert wire 40 and the rear insert wire 50 in these positions should be avoided. Further, disposing the front insert wire 40 and the rear insert wire 50 at a position P3 ahead of the front suspending groove 71 and a position P4 behind the rear suspending groove 72 should also be avoided, in terms of improving the sitting comfort performance and the posture stability described above. In a case where a concave portion 21s, to install the air conditioning mat 90, is formed on the upper face of the seat pad 21, the force to support the occupant (force to push back against the occupant) is stronger as the seat pad 21 is thicker. If the air conditioning mat 90 is installed, however, the seat pad 21 becomes thinner accordingly, so it is preferable to dispose the insert wires not in the rear portion behind the rear end 91 of the air conditioning mat 90 where the seat pad 21 is thick, but under the air conditioning mat 90 (portion where the seat pad 21 is thin), then the supporting force of the pad, which is reduced by the thickness of the air conditioning mat 90, can be compensated for by the insert wires.

### Total Width of Insert Wire

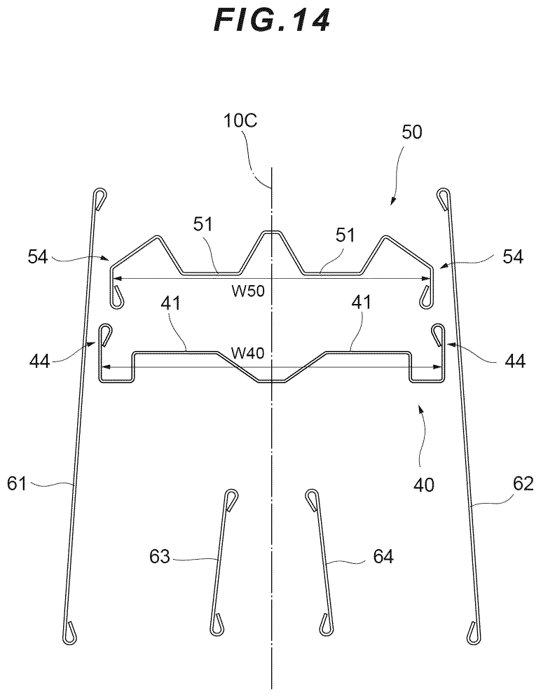

To match the styling design of the vehicle seat 10, the total width (length in the left-right direction) W50 of the rear insert wire 50 can be set to be narrower than the total width W40 of the front insert wire 40 (see FIG. 14).

### Relationship with Air Conditioning Mat

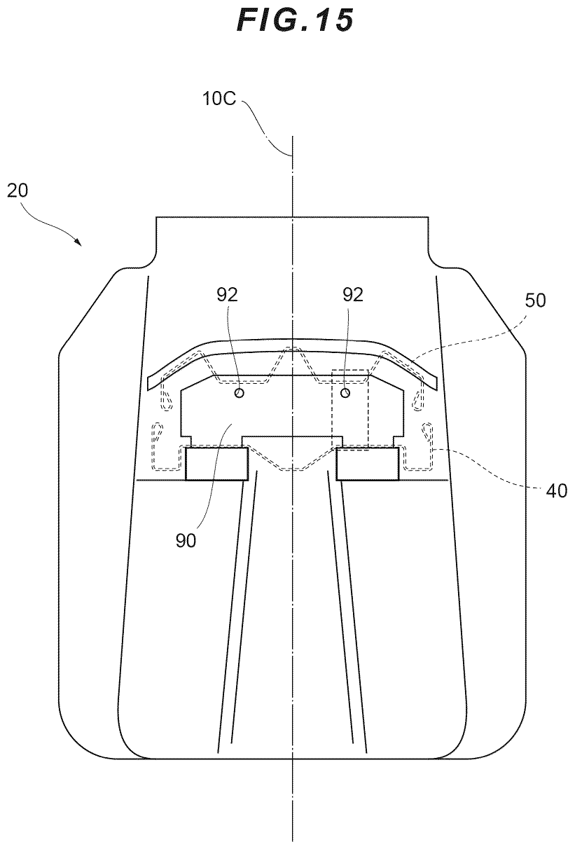

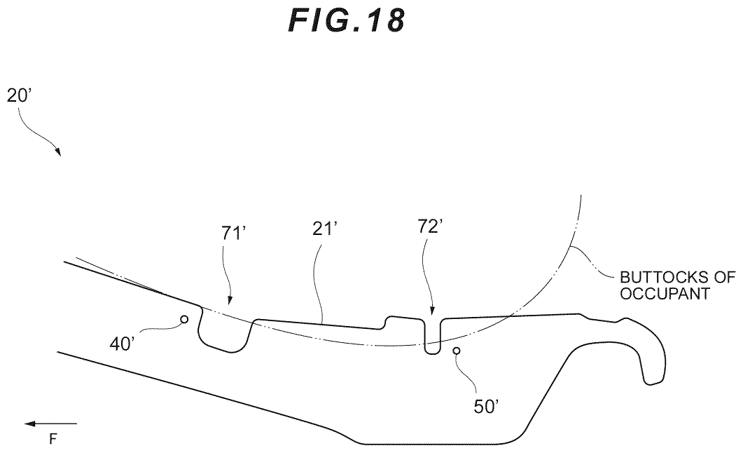

Vent holes 92 of the air conditioning mat 90, which are located under the buttocks H1 of the occupant, may be disposed within the broken line rectangular portion indicated in FIG. 15 (see FIG. 15). However, if the insert wires are at this position (see FIG. 16 and FIG. 18), sinking of the pelvis H2 of the occupant (buttocks sinking) is relatively large, and forward slippage and a shearing sensation may be generated, and thereby the vent holes 92 disposed at target positions may deviate from the actual sitting position. However, according to the vehicle seat 10, the sitting position can be stabilized while improving the sitting comfort performance as described above, and thereby the vent holes 92 of the air conditioning mat 90 can exhibit the expected air conditioning functions.

The above described embodiment is an example of a preferred embodiment of the present disclosure, but the present disclosure is not limited to this example, and may be modified in various ways within the scope not departing from the spirit of the disclosure.

The present disclosure can be preferably applied to a vehicle seat.

What is claimed is:

1. A vehicle seat, comprising:
a seat including a seat pad, a front insert wire which is disposed inside the seat pad, and a rear insert wire which is disposed inside the seat pad and is disposed on the rear side of the front insert wire in a front-back direction of the vehicle seat;
a backrest which is reclinable around a turning fulcrum; and
a suspending structure configured to suspend and support a seat cover by engaging suspended portions of the seat cover with a front suspending groove and a rear suspending groove formed in the seat pad, wherein
the front insert wire, which is bent at a plurality of bent portions, includes a front main load receiving portion which protrudes backward from a peripheral portion,
the rear insert wire, which is bend at a plurality of bent portions, includes a rear main load receiving portion which protrudes forward from a peripheral portion,
the rear insert wire is disposed at a position where at least the rear main load receiving portion is ahead of the rear suspending groove, and
the front insert wire is disposed at a position where at least the front main load receiving portion is behind the front suspending groove.

2. The vehicle seat according to claim 1, wherein
at least one of the front main load receiving portion and the rear main load receiving portion is constituted of a straight portion which extends in a left-right direction of the vehicle seat.

3. The vehicle seat according to claim 1, wherein
at least one of the front main load receiving portion and the rear main load receiving portion is formed to be bilaterally symmetrical with respect to a center line of the vehicle seat in the left-right direction.

4. The vehicle seat according to claim 1, wherein
the front insert wire is inclined in a side view of a vehicle seat, so as to be lower in a backward direction.

5. The vehicle seat according to claim 4, wherein
the rear insert wire is inclined in the side view of the vehicle seat, so as to be lower in a forward direction, from a peripheral portion of the rear main load receiving portion to the rear main load receiving portion.

6. The vehicle seat according to claim 5, wherein
the rear main load receiving portion is located at a lowest point in the rear insert wire.

7. The vehicle seat according to claim 1, wherein
a length of the front main load receiving portion in the left-right direction is longer than the length of the rear main load receiving portion in the left-right direction.

8. The vehicle seat according to claim 1, wherein
the rear insert wire and the front insert wire are disposed such that at least a part of the front main load receiving portion is located ahead of the rear main load receiving portion.

9. The vehicle seat according to claim 1, wherein
a number of bent portions of the front insert wire and a number of the bent portions of the rear insert wire are the same.

10. The vehicle seat according to claim 1, wherein
the bent portion of the rear insert wire is bent at an obtuse angle.

11. The vehicle seat according to claim 1, wherein
the front insert wire is disposed behind the front suspending groove, and
the rear insert wire is disposed ahead of the rear suspending groove.

12. The vehicle seat according to claim 1, wherein
the rear insert wire is disposed at a position where a distance from the turning fulcrum to the rear main load receiving portion is at least 170 mm, and
the front insert wire is disposed at a position where the distance between the rear main load receiving portion and the front main load receiving portion is at least 60 mm and not more than 70 mm.
